(19) United States
(12) Patent Application Publication
(10) Pub. No.: US 2014/0041289 A1
(43) Pub. Date: Feb. 13, 2014

(54) ALL PURPOSE GROUND COVER AND METHOD FOR MAKING THE SAME

(71) Applicant: Joseph Mingolello, Higganum, CT (US)

(72) Inventor: Joseph Mingolello, Higganum, CT (US)

(21) Appl. No.: 13/783,796

(22) Filed: Mar. 4, 2013

Related U.S. Application Data
(60) Provisional application No. 61/605,991, filed on Mar. 2, 2012.
(60) Provisional application No. 61/718,414, filed on Oct. 25, 2012.

(51) Int. Cl. A01G 13/00

(52) U.S. Cl. CPC A01G 13/0262
USPC 47/9

(57) ABSTRACT

An all purpose ground cover is presented for use in a landscape, walk or pathway, driveway or roadway, or other application. The ground cover includes a plurality of particles of stone, gravel or aggregate material, mulch or wood chips, or other natural and/or artificial materials and combinations thereof, mixed with an adhesive or bonding agent to form a coated material that can be easily installed within a portion of an area of application. For example, the coated material, which is moist and pliable before curing, may be shoveled and then raked level in a desired position within the landscape, walk or pathway, driveway or roadway application. Once the adhesive agent cures and hardens the coated material including the plurality of particles is substantially fastened and held together to provide the ground cover.

### CROSS-REFERENCE TO RELATED APPLICATIONS

This patent application claims benefit under 35 U.S.C. §119(e) of copending, U.S. Provisional Patent Applications Ser. Nos. 61/605,991, filed Mar. 2, 2012, and 61/718,414, filed Oct. 25, 2012, the disclosures of which are incorporated by reference herein in their entireties.

### BACKGROUND OF THE INVENTION

1. Field of the Invention

This invention relates generally to all purpose ground covers used in landscaping, pathway, driveway, roadway and other applications and, in particular, to a ground cover with improved properties for responding to changing natural and/or manmade environmental conditions and inhibiting unintended dispersion of the ground cover once installed to enhance a useful life of the ground cover in its intended application.

2. Description of Related Art

Generally speaking, ground cover is installed in an uncompressed or compressed manner around walk or path ways, driveways, plant beds, foundations for buildings, signage or other structures of interest, swimming pools, play grounds, and other areas within a commercial or residential landscape to improve ornamental features of the landscape, to hide components of lighting, drainage, irrigation or like systems serving the landscape, to inhibit growth of unwanted plants (e.g., weeds and the like), to discourage erosion of underlying soil, or other reasons. Some typical types of conventional ground cover include ornamental or other types of particles including stones, mulch, wood chips, or other natural and/or artificial landscape materials. Given the size and weight of individual pieces or particles of such landscape material that is employed within conventional ground covers, the material is easily moved. Such properties assist in the initial installation of the ground cover, as most conventional ground cover is shoveled and raked into a desired position. However, these same relatively small sized and light weight properties often allow the ground cover to be easily dispersed by naturally occurring weather such as wind, rain, and changing soil conditions in response to, for example, frost, by wear from foot traffic, by seasonal workers as when blown by lawn mowers or leaf blowers, raked by landscapers collecting, for example, leaves or clippings from the surface of the ground cover, or shoveled or plowed by workers clearing the walk or path ways, driveways or the like. The potential for dispersion increases when the landscape application includes using the ground cover in a sloped or otherwise inclined area. Over time, conventional ground cover materials are dispersed such that periodic (often yearly) replacement is required. Moreover, some types of natural ground cover such as, for example, mulch or wood chips, if left untreated, fade in color and deteriorate and/or may be consumed by insects over time contributing to a need for periodic replacement. Additionally, some types of natural ground cover such as, for example, mulch or wood chips, may be burn if subject to cigarettes, matches and the like discarded into the landscape by passersby.

In geographic areas that experience significant seasonal weather changes such as, for example, the North East region of the United States, areas of a landscape, walk or pathways, driveways and roadways expand and contract as moisture freezes and thaws. Over time, such expansion and contraction contribute to moving and loosening particles within conventional ground cover applications that can lead to further unintended dispersion of the ground cover.

Accordingly, the inventor has recognized that there is a need for ground cover that is relatively easy to install and which avoids the need for the typically yearly replacement or replenishment of materials.

### SUMMARY OF THE INVENTION

The present invention includes an all purpose ground cover including a plurality of particles of at least one of stone, rock, gravel or aggregate material, mulch, wood chips, or other natural and/or artificial materials used for landscape, walk or pathways, driveways and roadways, and an adhesive agent applied to coat the materials and combinations thereof and, once cured, hardens to substantially fasten and hold the materials or combinations thereof together.

In one aspect of the invention, the stone, gravel, aggregate material or combinations thereof is comprised of washed, stone, gravel, and aggregate material. In one embodiment, the aggregate material may be comprised of chopped or ground asphalt such as, for example, from material that was previously installed and removed from a walk, path, driveway or roadway application. The washed stone, gravel, aggregate material or combinations thereof is comprised of particles having a nominal diameter from about 0.031 inch to about 1.250 inches, and preferably, particles having a nominal diameter of about 0.625 inch for landscape applications and 0.25 to 1.0 inch for walk, path, driveway and roadway applications.

In another aspect of the invention, the adhesive agent is comprised of a silicone based adhesive having a long-term ability to resist ultraviolet radiation, weathering due to variations in humidity and temperature, is substantially resist a change in color, elasticity and adhesive strength. In one embodiment, the adhesive agent has a viscosity from about 1,000 to 15,000 centipoise such that, prior to curing, the coated materials or combinations thereof may be installed by spraying into a portion of landscape, walk or pathways, driveways and roadways to be covered.

### BRIEF DESCRIPTION OF THE DRAWINGS

The features and advantages of the present invention will be better understood when the Detailed Description of the Preferred Embodiments given below is considered in conjunction with the figures provided.

FIG. 1 depicts a process for mixing ground cover particles with a bonding agent to form an inventive ground cover, in accordance with one embodiment of the present invention.

FIG. 2A is a partial prospective view of the ground cover of FIG. 1 being installed in a landscape application, in accordance with one embodiment of the present invention.

FIG. 2B is a partial prospective view of the ground cover of FIG. 1 being installed in a pathway, driveway or roadway application, in accordance with one embodiment of the present invention.

FIG. 3 depicts a process for in-transmit mixing, delivery and installation of the ground cover of FIG. 1 in a landscape application, in accordance with one embodiment of the present invention.

FIG. 4 depicts a portable container of uncured the inventive ground cover.

In these figures like structures are assigned like reference numerals, but may not be referenced in the description of all figures.

### DETAILED DESCRIPTION OF THE PREFERRED EMBODIMENTS

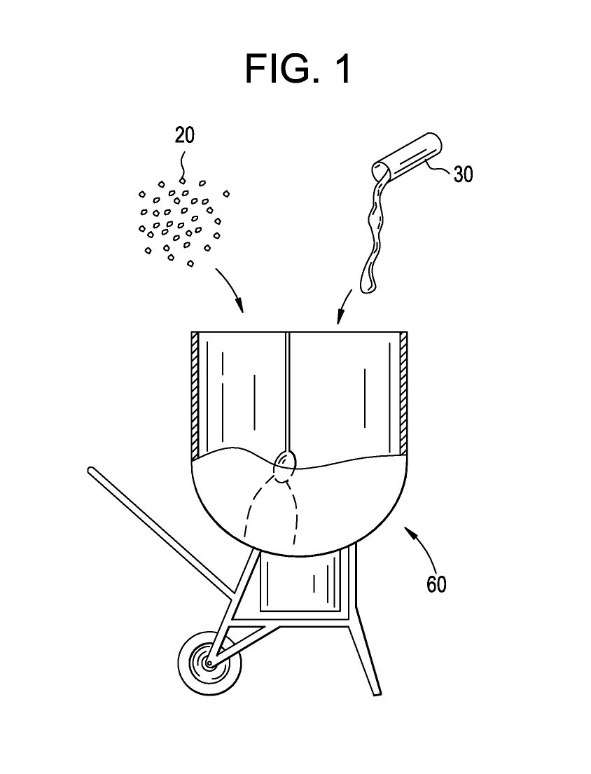

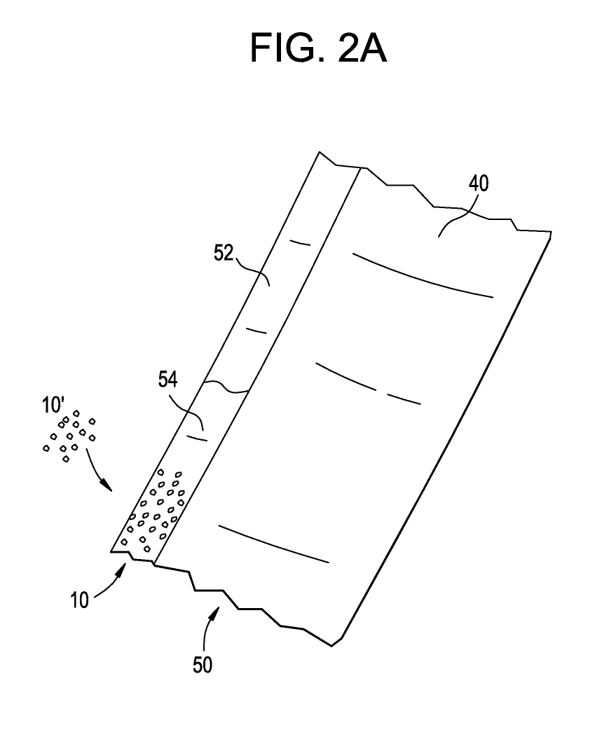

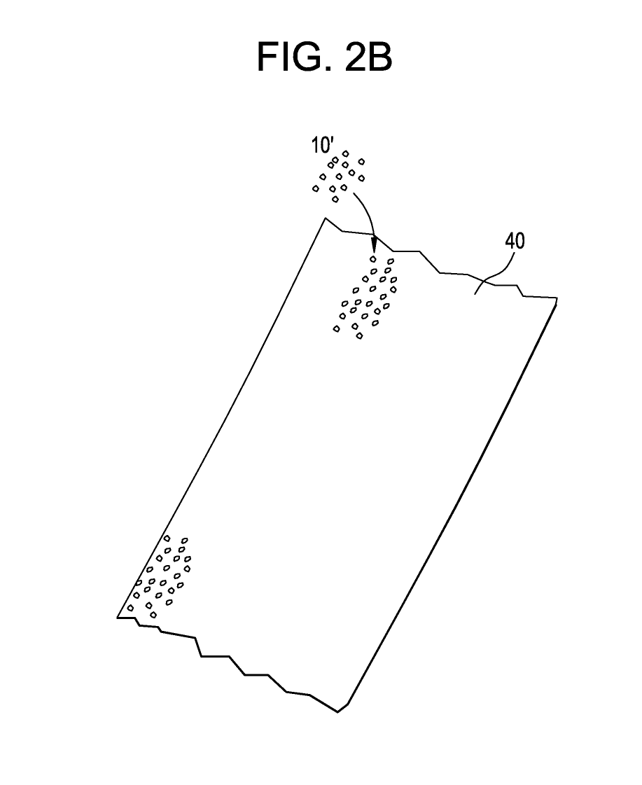

As shown in FIGS. 1-4, in accordance with the present invention, a ground cover 10 for use in a landscape, walk or pathway, driveway, roadway and other applications includes a plurality of particles including, for example, stone, rock, gravel, aggregate material (e.g., decomposed granite or the like, chopped or ground asphalt, concrete or the like from a previously installed and removed walk, path, driveway or roadway application, or the like), mulch, wood chips, or other natural and/or artificial materials, and combinations thereof 20, mixed with an adhesive or bonding agent 30 to form a coated material 10′ that can be easily installed within a portion of the landscape, walk or pathway, driveway, roadway and the like. For example, in one embodiment illustrated in FIG. 2A, the coated material 10′, which is moist and pliable before curing, may be shoveled and then raked level in a desired position (e.g., proximate a walkway 40) within a landscape 50. Once the adhesive or bonding agent 30 cures and hardens the coated material 10′ including the particles of stone, rock, gravel, aggregate material, mulch, wood chips, or other natural and/or artificial materials is substantially fastened and held together to provide the ground cover 10.

The inventor has discovered that the hardened ground cover 10 exhibits improved properties including being, for example, configured to be retained within the site of installation (e.g., inhibits unintended dispersion of the ground cover 10) while also being flexible (e.g., expands and contracts with surrounding soil) to respond to changing natural and/or manmade environmental conditions. It should be appreciated that even though hardened to inhibit dispersion, the ground cover 10 is permeable to permit the passage of liquids such as water, herbicides and other repellents, through to the soil below the ground cover 10. These properties are seen to enhance a useful life of the ground cover in its intended application. For example, and unlike conventional ground cover materials, not only is dispersion minimizes, if not substantially eliminated, the ground cover 10 does not fade in color, deteriorate and/or is not consumable by insects such that periodic replacement is minimized. Similarly, once installed and cured the inventive ground cover 10 is fire resistant and, as such, is not susceptible to burning if subjected to lit or smoldering cigarettes, matches and the like, discarded into the area of installation such as landscape, by passersby.

In the embodiment of FIG. 2A, the ground cover 10 is installed in an uncompressed manner as a sheet or blanket of bonded stone, rock, gravel, aggregate material, mulch, wood chips, or other natural and/or artificial materials. In another embodiment illustrated in FIG. 2B, the coated material 10′ is shoveled and then raked level in a desired position within the walkway 40 and is compressed or compacted to form a more uniform flat and/or smooth surface suitable for foot and/or vehicle (e.g., when installed in a driveway or roadway) traffic. It should be appreciated that in this compressed or compacted application the ground cover 10 is configurable to patch and/or repair the walkway, driveway, roadway or other surface 40, as well as being configurable in the initial formation of the surface 40. It should also be appreciated that while it is preferable to compress or compact the ground cover 10 for use in walk or pathways, driveways and roadways, compression and compaction is not required to achieve the benefits of the present invention.

As should be appreciated, when cured the ground cover 10 provides the aforementioned benefits of conventional ground cover, namely, providing improved ornamental features to the landscape, walk or pathway, driveway and roadway application, an ability to hide components of lighting, drainage, irrigation or like systems serving the landscape, walk or pathway, driveway and roadway application, an ability to inhibit growth of unwanted plants (e.g., weeds and the like) about the application area, an ability to discourage erosion of underlying soil and the like about the application area. Moreover, the inventive ground cover 10 substantially prevents unintended dispersion of individual ones of the particles of stone, gravel or aggregate material, mulch, wood chips, or other natural and/or artificial materials 20 by natural and/or manmade environmental conditions such as, for example, weather such as wind, rain, and changing soil conditions in response to, for example, frost, by wear from vehicle and foot traffic, or by seasonal workers as when blown by lawn mowers or leaf blowers, or raked by landscapers collecting, for example, leaves or clippings from the surface of the ground cover 10, thus enhancing a useful life of the ground cover in its intended application. The ground cover 10 may also be periodically washed to improve its look by, for example, a spray hose or power washer to remove dirt and debris without dislodging the particles of the plurality of stone, gravel or aggregate material, mulch, wood chips, or other natural and/or artificial materials 20 within the ground cover 10. Additionally, the cured ground cover 10, due to properties of the adhesive or bonding agent 30, maintains a flexible property such that the ground cover 10 adapts to expansion and/or contraction of underlying soil. For example, the ground cover 10 flexes and moves with the expansion and contraction of the underlying soil in response to seasonal frost, freezing and thaw cycles.

In one embodiment, the particles of stone, gravel or aggregate material 20 may be comprised of washed (e.g., double washed) stone, gravel or aggregate particles having a nominal diameter from about 0.031 inch to about 2.00 inches. The inventor has discovered that a nominal diameter of about 0.625 inch is preferred for many commercial and residential ground cover applications. The inventor has also discovered that it is desirable to use washed stone, gravel or aggregate such that dirt and other debris is removed that may adversely affect adhesion and cure time. In one embodiment, where a decorative or ornamental look is desired, the washed, stone may be comprised of “river stone” or “pea gravel” for a multi-colored effect, granite for a “gray” color effect, or any other materials having a suitable or desired color or shade such as, for example, black, brown, white, red, orange, variations thereof, from natural stone materials such as limestone, marble, slate, sandstone and the like.

While described above as being a ground cover having particles of a nominal diameter from about 0.031 inch to about 2.00 inches, it should be appreciated that larger diameter materials including, for example, up to 10.0 inches or more diameter, may be used to form, for example, secure decorative rock formations about a landscape, stone walls for decorative or retaining purposes with the landscape. Additionally, and as described in detail below, the coated material 10′ including the plurality of stone, rock, gravel or aggregate and the adhesive or bonding agent 30 may be rolled or otherwise affixed to, for example, cement board or other backing, and used as interior or exterior walls and portions thereof.

In one embodiment, the inventive ground cover 10 may be comprised of particles 20 of natural (e.g., organic) materials such as, for example, mulch and wood chips and artificial (e.g., inorganic) materials such as, for example, polymers including recycled rubber from tires and the like. As some natural and artificial materials may fade in color and/or deteriorate over time, mixing and, in effect, encasing the materials with the adhesive or bonding agent 30 is seen to provide a longer useful life to these materials in the intended application.

In one embodiment, the adhesive or bonding agent 30 is comprised of a silicone based adhesive having a long-term ability to resist ultraviolet radiation, weathering due to variations in humidity, temperature. As described herein, these preferred properties substantially resist a change in color, elasticity and adhesive strength. In one embodiment, the adhesive or bonding agent 30 has a high viscosity (e.g., about 1,000 to 15,000 centipoise (cP)) such that prior to curing, the coated material 10′ may be installed by spraying the coated material 10′ into the intended application, for example, the portion of the landscape, walk or pathway, driveway or roadway, or other application. As noted above, one property of the preferred adhesive or bonding agent 30 is a resistance to color change. The inventor has discovered that an adhesive or bonding agent 30 that cures to be clear, or at least substantially translucent if not completely transparent, enhances the appearance or “brilliance” of colored or decorative stone, gravel or aggregate material, mulch or wood chips, or other natural and/or artificial materials 20 within the ground cover 10. That is, when cured, the clear adhesive agent 30 impairs a shine, polish or luster that enhances the overall ornamental appearance of the particles comprising the ground cover 10. The inventor has found that a suitable adhesive agent 30 is sold under the brand name SILSHIELD by Momentive Performance Materials Inc. (Wilton, Conn. USA).

It should be appreciated that while described as being a silicone based adhesive, it is within the scope of the present invention to employ other liquid adhesives having similar properties of long-term ability to resist ultraviolet radiation, weathering due to variations in humidity, temperature, resist a change in color, and that have superior elasticity and adhesive strength. For example, the adhesive agent 30 may be comprised of an acrylic or a urethane based material. It should also be appreciated that while described above as employing an adhesive or bonding agent 30 that cures to be clear or translucent so as not to distract from or alter the ornamental features of the stone, gravel or aggregate material, mulch or wood chips, or other natural and/or artificial materials 20, it is also within the scope of the present invention to employ an adhesive or bonding agent 30 that, when cured, has a color or shade which is imparted to the ground cover 10. Alternatively, a color may be added to the adhesive or bonding agent 30 prior to curing, or be introduced to the particles of stone, gravel or aggregate material, mulch or wood chips, or other natural and/or artificial materials 20 as it is being washed, prior to mixing with the adhesive or bonding agent 30. It should be appreciated that any color may be used as is required, preferred or desirable for a particular application.

It should also be appreciated that the cure time for the adhesive or bonding agent 30 may vary in accordance with a given material selected and the manufacturer's recommendations, as well as the environmental conditions at installation (e.g., humidity, temperature, and the like). The inventor has found that it preferable to use an adhesive or bonding agent having a cure time that permits contact with, e.g., at least touching or walking on, the ground cover 10 of between about five (5) and seventy-two (72) hours.

Turning to mixing of the ground cover 10, it is recommended for relatively small scale installations, that the mixing of stone, gravel or aggregate material, mulch or wood chips, or other natural and/or artificial materials 20 and the adhesive or bonding agent 30 to form the coated material 10′ is done in relatively close proximity to the intended application, e.g., portion of the landscape, walk or pathway, driveway or roadway, or other application where the ground cover 10 is to be employed. In one embodiment, illustrated in FIGS. 1 and 2, the ground cover 10 is installed with use of a conventional cement mixer such as, for example, a portable mixer 60 (FIG. 1) having a capacity or volume of about, for example, four (4) to five (5) or more cubic feet. In this embodiment, a mixing operation includes adding a first quantity of the adhesive or bonding agent 30 of about, for example, thirty-two fluid ounces (32 fl. oz.) added to an otherwise empty thought operating (e.g., turning) mixer 60, followed by a first quantity of the stone, gravel or aggregate material, mulch or wood chips, or other natural and/or artificial materials 20 of, for example, about thirteen (13) shovels of the material or until the capacity of the mixer 60 is about one half full (e.g., about 2 cubic feet of material). Once the first quantity of the material 20 is added, a second quantity of the adhesive or bonding agent 30 of about, for example, thirty-two fluid ounces (32 fl. oz.) is added to the turning mixer 60 including the first quantities of adhesive agent 30 and material 20. The second quantity of the adhesive or bonding agent 30 is then followed by a second quantity of the stone, gravel or aggregate material, mulch or wood chips, or other natural and/or artificial materials 20 of, for example, about fourteen (14) shovels of the materials 20 or until the capacity of the mixer 60 is about full (e.g., between about 2 to 3 cubic feet of additional material is added). Once the second quantity of the stone, gravel or aggregate material, mulch or wood chips, or other natural and/or artificial materials 20 is added to the mixer 60, a third quantity of the adhesive or bonding agent 30 of about, for example, thirty-two fluid ounces (32 fl. oz.) is added to the turning mixer 60 to reach a mixing ratio of about ninety-six ounces (96 oz.) of adhesive or bonding agent 30 to about 27 shovel loads of the stone, gravel or aggregate material, mulch or wood chips, or other natural and/or artificial materials 20 to form the about four (4) to five (5) cubic feet of the coated material 10′. The aforementioned mixing process using a portable mixer 60 can be completed in a relatively short timeframe of about five (5) to ten (10) minutes, or more or less time to ensure that the stone, gravel or aggregate material, mulch or wood chips, or other natural and/or artificial materials 20 is relatively uniformly coated with the adhesive or bonding agent 30.

While described above as one mixing ratio (e.g., about ninety-six ounces of adhesive agent 30 to about 27 shovel loads of the stone, gravel or aggregate material, mulch or wood chips, or other natural and/or artificial materials 20 for about 4 to 5 cubic feet of material) and five step operation, it is within the scope of the present invention to vary the amount or ratio of stone, gravel or aggregate material, mulch or wood chips, or other natural and/or artificial materials 20 to the adhesive or bonding agent 30 and alternating steps of adding agent 30 and material 20 on an application by application basis. For example, the aforementioned mixing process may be varied by adding four (4) steps of thirty-two fluid ounces (32 fl. oz.) of adhesive agent 30 (128 fl. oz. in total) to about 27 shovel loads of the stone, gravel or aggregate material, mulch or wood chips, or other natural and/or artificial materials 20 to provide a more dense coating on the about 4 to 5 cubic feet of materials 20. The inventor has found that a higher ratio of adhesive agent 30 to the material 20 provides a more durable ground cover 10 that can be employed in higher foot traffic areas, or paths, driveways, roadways and the like for vehicles such as golf carts, cars, trucks and other motor vehicles.

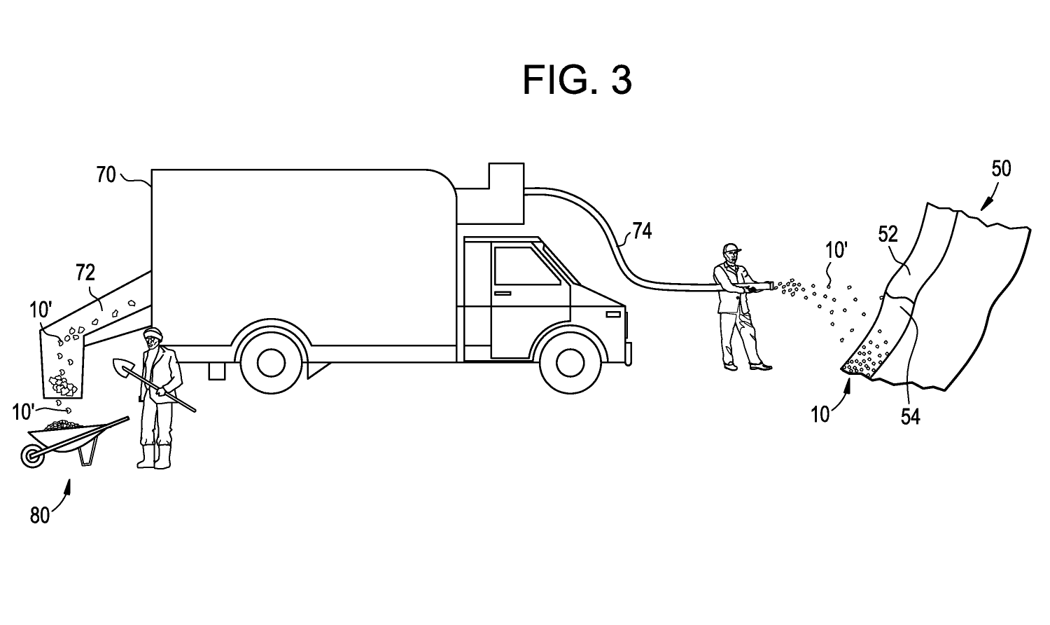

As shown in FIG. 3, for relatively large scale installations, the coated material 10′ for the ground cover 10 of stone, gravel or aggregate material, mulch or wood chips, or other natural and/or artificial materials 20 and the adhesive or bonding agent 30, is initially mixed off-site, and delivered to the area of application 50, e.g., landscape, walk or pathway, driveway or roadway, or other application, where the ground cover 10 is to be employed by one or more in-transit mixing trucks 70 such as a conventional cement mixing trucker. As is generally known, the truck 70 may include one or more outlets for unloading the coated material 10′ by chute 72 for a wheel barrel 80 feed to the installer, or by coupling to a hose, pump and nozzle, shown generally at 74, for a spray feed by the installer to the area of application 50. Typically, each truck can provide a capacity or volume of about, for example, ten (10) to twelve (12) or more cubic yards of the coated material 10′. As can be appreciated, the mixing operation outlined above is varied as the volume of materials increases from a capacity or volume of, for example, about four (4) to five (5) cubic feet from the portable mixer 60 (FIG. 1) to a capacity or volume of, for example, about ten (10) to twelve (12) cubic yards of the coated material 10′. For example, as described above, one mixing ratio for the about four (4) to five (5) cubic feet capacity of the portable mixer 60 is about ninety-six ounces (96 oz.) of adhesive or bonding agent 30 to about 27 shovel loads of the stone, gravel or aggregate material, mulch or wood chips, or other natural and/or artificial materials 20. Using a similar ratio, a mixing ratio for the about ten (10) to twelve (12) cubic yards capacity of the truck 70 is about fifty (50) gallons or 6,480 fl. oz. (96 oz. to 4-5 cubic feet, is about 24 fl. oz. per cubic foot, times 27 for a cubic yard conversion, and then times 10 for the 10 yard capacity of the truck 70) of adhesive or bonding agent 30 to about 10 cubic yards of the stone, gravel or aggregate material, mulch or wood chips, or other natural and/or artificial materials 20.

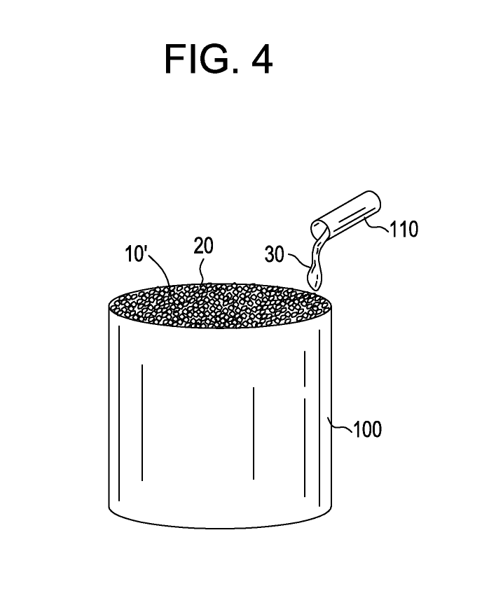

As shown in FIG. 4, in one embodiment, for relatively small or so called do-it-yourself installations, the coated material 10′ including particles of stone, gravel or aggregate material, mulch or wood chips, or other natural and/or artificial materials 20 and the adhesive or bonding agent 30, is initially mixed off-site, and delivered to installers or consumers in a portable container 100 such as, for example, a five (5) gallon bucket. It should be appreciated that the portable container 100 is vacuum packed or otherwise sealed to prevent premature curing of the adhesive or bonding agent 30 within the container 100. In one embodiment, the portable container 100 may include a secondary container 110 including a secondary supply of the adhesive or bonding agent 30. Alternatively, the portable container 100 includes separate (e.g., non-mixed) portions of the particles of stone, gravel or aggregate material, mulch or wood chips, or other natural and/or artificial materials 20 and the adhesive or bonding agent 30, where the adhesive or bonding agent 30 is included in the secondary container 110 and not pre-mixed with the materials 20. As should be appreciated, in this alternative embodiment, sealing of the portable container 100 is not necessary as the adhesive or bonding agent 30 is retained within the secondary container 110 until just prior to installation when it is mixed with the particles of stone, gravel or aggregate material, mulch or wood chips, or other natural and/or artificial materials 20 to form the coated material 10′ and used in the area of application, e.g., the landscape, walk or pathway, driveway or roadway, or other application.

In one embodiment, for example, to further improve the useful life of the ground cover 10, it is within the scope of the present invention to periodically spray, roll, brush, or otherwise apply a top coat of the adhesive agent 30 after the ground cover 10 has been installed and/or used for a period of time. It should be appreciated that the mil thickness of the applied spray coating may vary on an application by application basis within the subject landscape and/or desired shine, polish or brilliance to be improved or maintained.

Turning to installation of the ground cover 10, it is recommended that the wet, mixed coated material 10′ be added to a prepared area of the landscape 50. For example, an initial installation step includes excavating and leveling an underlying base of soil 52 within the landscape 50. Optionally, a layer of weed inhibiting landscape fabric 54 is then installed over the prepared soil 52. The wet mixed coated material 10′ may then be shoveled or poured from the mixer 60 onto the soil 52 or the fabric 54 (if used) and raked or otherwise leveled to a desired thickness of the finished ground cover 10. It most landscape applications, a thickness of the ground cover 10 of about one and one half inches (1.5 inches) to about two inches (2 inches) is preferred. Once a desired thickness is achieved, the coated material 10′ is allowed to air dry to cure into the ground cover 10. In one embodiment, the coated material 10′ may be compacted or compressed, for example, as when used in a walk or pathway, driveway or roadway.

It should also be appreciated that while described as a ground cover, it is within the scope of the present invention to employ the coated material 10′ in other applications such as, for example, a coating on a foundation, landscape features such as, for example, a fountain, block wall, or the like, or as a coating on cement board or other backing material for use as an interior or exterior wall, door, countertop, or other surface to improve the ornamental appearance of the surface and to make the surface appears as if it is made of stone.

Although the invention has been described with reference to particular embodiments thereof, it should be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A ground cover, comprising:
a plurality of particles including at least one of stone, rock, gravel or aggregate material, mulch or wood chips, or other natural and/or artificial materials, and combinations thereof; and
an adhesive agent applied to coat the plurality of particles and once cured hardens to substantially fasten and hold the plurality of particles together.

2. The ground cover of claim 1, wherein the plurality of particles of stone, gravel, aggregate material or combinations thereof is comprised of washed, stone, gravel, aggregate material.

3. The ground cover of claim 1, wherein the plurality of particles of stone, gravel, aggregate material or combinations thereof is comprised of particles having a nominal diameter from about 0.031 inch to about 2.00 inches.

4. The ground cover of claim 1, wherein the plurality of particles of stone, gravel, aggregate material or combinations thereof is comprised of particles having a nominal diameter of about 0.625 inch.

5. The ground cover of claim 1, wherein the adhesive agent is comprised of a silicone based adhesive having a long-term ability to resist ultraviolet radiation, weathering due to variations in humidity and temperature, is substantially resist a change in color, elasticity and adhesive strength.

6. The ground cover of claim 5, wherein the adhesive agent has a viscosity from about 1,000 to 15,000 centipoise such that prior to curing the coated at least one of stone, gravel, aggregate material or combinations thereof may be installed by spraying into a portion of landscape to be covered.
